(19) United States
(12) Patent Application Publication
(10) Pub. No.: US 2005/0001551 A1
(43) Pub. Date: Jan. 6, 2005

(54) Plasma display panel

(76) Inventors: Woo-Tae Kim, Yongin-si (KR); Kyoung-Doo Kang, Seoul (KR); Hun-Suk Yoo, Cheonan-si (KR); Seok-Gyun Woo, Asan-si (KR); Jae-Ik Kwon, Asan-si (KR)

Correspondence Address: CHRISTIE, PARKER & HALE, LLP, PO BOX 7068, PASADENA, CA, 91109-7068, US

(21) Appl. No.: 10/884,829

(22) Filed: Jul. 2, 2004

(30) Foreign Application Priority Data
Jul. 4, 2003 (KR) 2003-0045200
Jul. 11, 2003 (KR) 2003-0047144
Jul. 11, 2003 (KR) 2003-0047145
Jul. 22, 2003 (KR) 2003-0050278
Jul. 30, 2003 (KR) 2003-0052598
Aug. 1, 2003 (KR) 2003-0053461
Sep. 4, 2003 (KR) 2003-0061838

(51) Int. Cl. H01J 17/49

(52) U.S. Cl. 313/584; 313/585; 313/582

(57) ABSTRACT

A plasma display panel. A first substrate and a second substrate are provided opposing one another with a predetermined gap therebetween. Address electrodes are formed on the second substrate. Barrier ribs are mounted between the first substrate and the second substrate, the barrier ribs defining a plurality of discharge cells and a plurality of non-discharge regions. Phosphor layers are formed within each of the discharge cells. Discharge sustain electrodes are formed on the first substrate. The non-discharge regions are formed in areas encompassed by discharge cell abscissas that pass through centers of adjacent discharge cells and discharge cell ordinates that pass through centers of adjacent discharge cells, the non-discharge regions having a width that is at least as large as a width of an end of barrier ribs. Also, a transverse barrier rib is formed extending between each pair of adjacent rows of discharge cells.

### CROSS REFERENCE TO RELATED APPLICATIONS

This application claims priority to and the benefit of Korea Patent Applications: No. 2003-0047144 filed on Jul. 11, 2003, No. 2003-0047145 filed on Jul. 11, 2003, No. 2003-0045200 filed on Jul. 4, 2003, No. 2003-0050278 filed on Jul. 22, 2003, No. 2003-0052598 filed on Jul. 30, 2003, No. 2003-0053461 filed on Aug. 1, 2003 and No. 2003-0061838 filed on Sep. 4, 2003, all in the Korean Intellectual Property Office, the entire content of which are incorporated herein by reference.

### BACKGROUND OF THE INVENTION

(a) Field of the Invention

The present invention relates to a plasma display panel (PDP), and more particularly, to a PDP having a barrier rib structure between two substrates that defines discharge cells into independent units.

(b) Description of the Related Art

A PDP is typically a display device in which ultraviolet rays generated by the discharge of gas excite phosphors to realize predetermined images. With its ability to realize high-resolution images, the PDP is emerging as one of the most popular flat panel display configurations used for wall-mounted televisions and other similar large-screen applications.

In a conventional PDP, with reference to FIG. 23, address electrodes 101 are formed along one direction (direction X in the drawing) on rear substrate 100. Dielectric layer 103 is formed over an entire surface of rear substrate 100 on which address electrodes 101 are located such that dielectric layer 103 covers address electrodes 101. Barrier ribs 105 are formed on dielectric layer 103 in a striped pattern and at locations corresponding to between address electrodes 101. Formed between barrier ribs 105 are red, green, and blue phosphor layers 107.

Formed on a surface of front substrate 110 facing rear substrate 100 are discharge sustain electrodes 114. Each of the discharge sustain electrodes 114 includes a pair of transparent electrodes 112 and a pair of bus electrodes 113. Transparent electrodes 112 and bus electrodes 113 are arranged in a direction substantially perpendicular to address electrodes 101 of rear substrate 100 (direction Y). Dielectric layer 116 is formed over an entire surface of front substrate 110 on which discharge sustain electrodes 114 are formed such that dielectric layer 116 covers discharge sustain electrodes 114. MgO protection layer 118 is formed covering entire dielectric layer 116.

Areas between where address electrodes 101 of rear substrate 100 and discharge sustain electrodes 114 of front substrate 110 intersect become areas that form discharge cells. Discharge gas fills the discharge cells, and the discharge gas effects discharge according to voltage signals applied to the above electrodes, and emits vacuum ultraviolet (VUV) rays to excite corresponding phosphors.

An address voltage Va is applied between address electrodes 101 and discharge sustain electrodes 114 to perform address discharge, then a sustain voltage Vs is applied between a pair of the discharge sustain electrodes 114 to perform sustain discharge. Ultraviolet rays generated at this time excite corresponding phosphor layers such that visible light is emitted through transparent front substrate 110 to realize the display of images.

However, with the PDP structure in which discharge sustain electrodes 114 are formed as shown in FIG. 23 and barrier ribs 105 are provided in a striped pattern, crosstalk may occur between adjacent discharge cells (i.e., discharge cells adjacent to one another with barrier ribs 105 provided therebetween). Further, since there is no structure provided between adjacent barrier ribs 105 for dividing the discharge cells, it is possible for mis-discharge to occur between adjacent discharge cells. To prevent these problems, it is necessary to provide a minimum distance between discharge sustain electrodes 114 corresponding to adjacent pixels. However, this limits efforts at improving discharge efficiency.

In an effort to remedy these problems, PDPs having improved electrode and barrier rib structures have been disclosed as shown in FIGS. 24 and 25.

In the PDP structure appearing in FIG. 24, although barrier ribs 121 are formed in the typical striped pattern, discharge sustain electrodes 123 are changed in configuration. That is, discharge sustain electrodes 123 include transparent electrodes 123a and bus electrodes 123b, with a pair of transparent electrodes 123a being formed for each discharge cell in such a manner to extend from bus electrodes 123b and oppose one another. U.S. Pat. No. 5,640,068 discloses a PDP with such a configuration. However, in the PDP structured in this manner, mis-discharge along the direction that barrier ribs 121 are formed remains a problem.

In the PDP structure appearing in FIG. 25, a matrix structure for barrier ribs 125 is realized. In particular, barrier ribs 125 include vertical barrier ribs 125a and horizontal barrier ribs 125b that intersect. Such a configuration is used with the goal of increasing a phosphor deposition area to enhance illumination efficiency. Japanese Laid-Open Patent No. Heisei 10-149771 discloses a PDP utilizing this structure.

However, with the use of such a matrix barrier rib structure, since all areas except for where the barrier ribs are formed are designed as discharge regions, there are only areas that generate heat and no areas that absorb or disperse heat. As a result, after operation for a certain amount of time, temperature differences occur between cells in which discharge occurs and in which discharge does not occur. These temperature differences not only affect discharge characteristics, but also result in differences in brightness, the generation of bright image stickings, and other such quality problems. Bright image stickings refers to a difference in brightness occurring between a localized area and its peripheries even after a pattern of brightness that is greater than its peripheries is displayed for a predetermined time interval then returned to the brightness of the overall screen.

### SUMMARY OF THE INVENTION

In accordance with the present invention, a plasma display panel is provided that optimizes a structure of barrier ribs that define discharge cells to thereby maximize discharge efficiency, and increase the efficiency of converting vacuum ultraviolet rays into visible light during discharge such that discharge stability is ensured.

In one embodiment of the present invention, a plasma display panel includes a first substrate and a second substrate provided opposing one another with a predetermined gap therebetween. Address electrodes are formed on the second substrate. Barrier ribs are mounted between the first substrate and the second substrate, the barrier ribs defining a plurality of discharge cells and a plurality of non-discharge regions. Phosphor layers are formed within each of the discharge cells. Discharge sustain electrodes are formed on the first substrate. The non-discharge regions are formed in areas encompassed by discharge cell abscissas that pass through centers of adjacent discharge cells and discharge cell ordinates that pass through centers of adjacent discharge cells, the non-discharge regions having a width that is at least as large as a width of an end of barrier ribs opposite an end adjacent to the second substrate. Also, a transverse barrier rib is formed extending between each pair of adjacent rows of discharge cells, where the “rows” of discharge cells are formed by the same adjacent in the direction substantially perpendicular to address electrodes, and the transverse barrier ribs intersecting the non-discharge regions.

The barrier ribs forming the discharge cells comprise first barrier rib members formed substantially parallel to the direction of the address electrodes, and second barrier rib members formed in a direction that is oblique to the direction of the address electrodes. There is a space between second barrier rib members adjacent along the direction of the address electrodes, and the transverse barrier ribs are formed in the spaces between the second barrier rib members.

The plasma display panel further includes at least one bridge barrier rib member interconnecting each pair of second barrier rib members adjacent along the direction of the address electrodes.

Each of the discharge cells is formed such that ends of the discharge cells gradually decrease in width along a direction the discharge sustain electrodes are formed as a distance from a center of the discharge cells is increased along a direction the address electrodes are formed. The ends of the discharge cells may be formed substantially in the shape of a trapezoid with its base removed, or may be arc-shaped.

The discharge sustain electrodes include bus electrodes that extend in a direction substantially perpendicular the direction of the address electrodes to be positioned outside areas of the discharge cells, and protrusion electrodes formed extending from each of the bus electrodes such that a pair of opposing protrusion electrodes is formed within areas corresponding to each discharge cell. Both sides of a proximal end of each of the protrusion electrodes where connected to the bus electrodes are formed substantially uniformly with inner walls of ends of the discharge cells along the direction of the address electrodes. Also, proximal ends of each of the protrusion electrodes where connected to the bus electrodes are formed decreasing in width along the direction of the bus electrodes as the distance from centers of the discharge cells is increased.

A distal end of at least one of each pair of protrusion electrodes opposite proximal ends connected to and extended from the bus electrodes is formed including an indentation, and a first discharge gap and a second discharge gap of different sizes are formed between distal ends of opposing protrusion electrodes. The discharge cells are filled with discharge gas containing 10% or more Xenon. In one embodiment, the discharge cells are filled with discharge gas containing 10-60% Xenon.

Ventilation paths are formed on the barrier ribs defining the non-discharge regions. The ventilation paths are formed as grooves in the barrier ribs to communicate the discharge cells with the non-discharge regions.

The discharge sustain electrodes include scan electrodes and display electrodes provided such that one scan electrode and one display electrode correspond to each row of the discharge cells, the scan electrodes and the display electrodes including protrusion electrodes that extend into the discharge cells while opposing one another. The protrusion electrodes are formed such that a width of proximal ends thereof is smaller than a width of distal ends of the protrusion electrodes. Also, the address electrodes include line regions formed along a direction the address electrodes are formed, and enlarged regions formed at predetermined locations and expanding along a direction substantially perpendicular to the direction of the line regions to correspond to the shape of protrusion electrodes of the scan electrodes.

The enlarged regions of the address electrodes are formed to a first width at areas opposing the distal ends of the protrusion electrodes, and to a second width that is smaller than the first width at areas opposing the proximal ends of the protrusion electrodes.

In another embodiment, a plasma display panel includes a first substrate and a second substrate provided opposing one another with a predetermined gap therebetween. Address electrodes are formed on the second substrate. Barrier ribs are mounted between the first substrate and the second substrate, the barrier ribs defining a plurality of discharge cells and a plurality of non-discharge regions. Phosphor layers are formed within each of the discharge cells. Discharge sustain electrodes are formed on the first substrate. The barrier ribs forming the discharge cells include first barrier rib members formed substantially parallel to the direction of the address electrodes, and second barrier rib members formed in a direction that is oblique to the direction of the address electrodes. Also, at least one bridge barrier rib member interconnects each pair of second barrier rib members adjacent along the direction of the address electrodes.

An end of the bridge barrier rib members opposite an end adjacent to the second substrate is substantially identical to a width of an end of the first barrier rib members opposite an end adjacent to the second substrate, and the second barrier rib members intersect the direction the address electrodes are formed.

A height of the first barrier rib members and a height of the second barrier rib members are different. The height of the first barrier rib members is greater than the height of the second barrier rib members, or the height of the first barrier rib members is less than the height of the second barrier rib members.

Each of the discharge cells is formed such that ends of the discharge cells gradually decrease in width along a direction the discharge sustain electrodes are formed as a distance from a center of the discharge cells is increased along a direction the address electrodes are formed. The ends of the discharge cells may be formed substantially in the shape of a trapezoid with its base removed, or may be arc-shaped.

The discharge sustain electrodes include bus electrodes that extend in a direction substantially perpendicular the direction of the address electrodes to be positioned outside areas of the discharge cells such that a pair of bus electrodes corresponds to each discharge cell, and protrusion electrodes formed extending from each of the bus electrodes such that a pair of opposing protrusion electrodes is formed within areas corresponding to each discharge cell. The bus electrodes pass over the second barrier rib members.

In yet another embodiment, the discharge cells have a pitch between centers of discharge cells adjacent along the direction of the address electrodes that is varied alternatingly along the same direction.

That is, two different pitches a, b are used between centers of the discharge cells such that pitch a is less than pitch b, and if the interval of pitch a is referred to as “A section”, and the interval of pitch b is referred to as “B section”, the discharge cells are formed such that A sections and B sections are alternatingly formed along the direction of the address electrodes.

The barrier ribs forming the discharge cells include first barrier rib members formed along the direction of the address electrodes, and second barrier rib members that are not parallel to the address electrodes. In the B sections, at least one bridge barrier rib member is formed between each pair of the discharge cells adjacent along the direction of the address electrodes, whereas the bridge barrier rib members are not formed in the A sections.

In the case of the A sections, the discharge cells are immediately adjacent to each other along the direction of address electrodes such that the pitch between centers of the discharge cells in the B sections is greater than the pitch between centers of the discharge cells in the A sections, the A sections having a pattern of X-X electrodes and the B sections having a pattern of Y-Y electrodes.

In still yet another embodiment, the discharge cells have a pitch between centers of discharge cells adjacent along the direction of the address electrodes that is varied alternatingly along the same direction. In particular, two different pitches a, b are used between centers of the discharge cells such that pitch a is less than pitch b, and if the interval of pitch a is referred to as “A section”, and the interval of pitch b is referred to as “B section”, the discharge cells are formed such that A sections and B sections are alternatingly formed along the direction of the address electrodes. Also, the A sections have one display electrode (X electrode) formed therein, and the B sections have a pair of scan electrodes (Y electrodes) formed therein.

A width of the display electrodes (X electrodes) along the direction of the address electrodes is greater than a width of the scan electrodes (Y electrodes) along the direction of the address electrodes.

A distal end of each of the protrusion electrodes opposite proximal ends connected to and extended from the bus electrodes is formed including an indentation.

### BRIEF DESCRIPTION OF THE DRAWINGS

FIG. 1 is a partial exploded perspective view of a plasma display panel according to a first embodiment of the present invention.

FIG. 2 is a partial plan view of the plasma display panel of FIG. 1.

FIG. 3 is a partial plan view of select elements in a plasma display panel according to a second embodiment of the present invention.

FIG. 4 is a partial plan view of select elements in a plasma display panel according to a third embodiment of the present invention.

FIG. 5 is a partial plan view of select elements in a plasma display panel according to a fourth embodiment of the present invention.

FIG. 6 is a partial plan view of a plasma display panel according to a fifth embodiment of the present invention.

FIGS. 7A and 7B are respectively a perspective view and a plan view of a ventilation path of FIG. 6.

FIGS. 8A and 8B are respectively a perspective view and a plan view of a modified example of a ventilation path of FIG. 6.

FIG. 9 is a partial exploded perspective view of a plasma display panel according to a sixth embodiment of the present invention.

FIG. 10 is a partial enlarged view of select elements of the plasma display panel of FIG. 9.

FIG. 11 is a partial exploded perspective view of a plasma display panel according to a seventh embodiment of the present invention.

FIG. 12 is a partial plan view of the plasma display panel of FIG. 11.

FIG. 13 is a partial exploded perspective view of a modified example of the plasma display panel of FIG. 11.

FIG. 14 is a partial plan view of a plasma display panel according to an eighth embodiment of the present invention.

FIG. 15 is a partial plan view of a plasma display panel according to a ninth embodiment of the present invention.

FIG. 16 is a partial exploded perspective view of a plasma display panel according to a tenth embodiment of the present invention.

FIG. 17 is a partial plan view of the plasma display panel of FIG. 16.

FIG. 18 is a partial exploded perspective view of a plasma display panel according to an eleventh embodiment of the present invention.

FIG. 19 is a partial plan view of the plasma display panel of FIG. 18.

FIGS. 20-22 are drawings showing modified examples of the plasma display panel of FIG. 18.

FIG. 23 is a partially cutaway perspective view of a conventional plasma display panel.

FIG. 24 is a partial plan view of a conventional plasma display panel having a striped barrier rib structure.

FIG. 25 is a partial plan view of a conventional plasma display panel having a matrix barrier rib structure.

### DETAILED DESCRIPTION

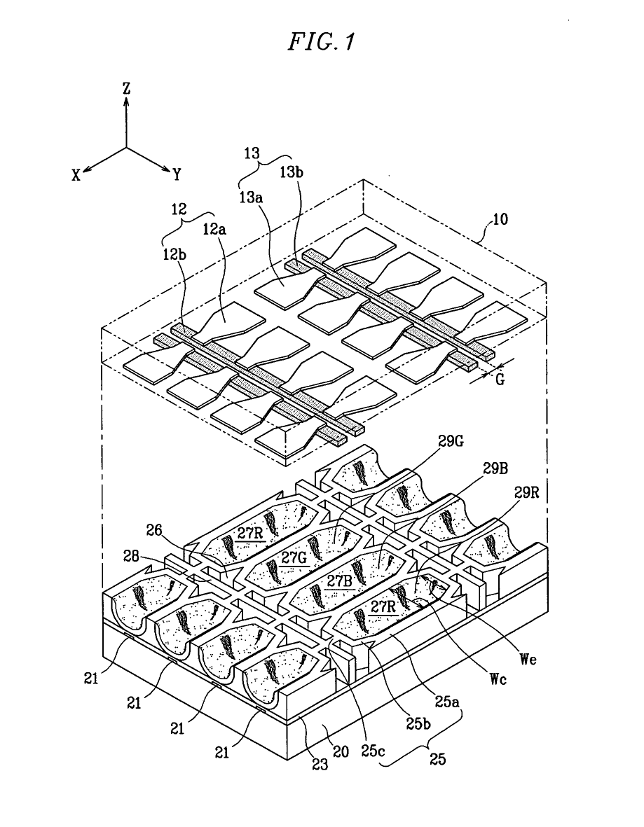

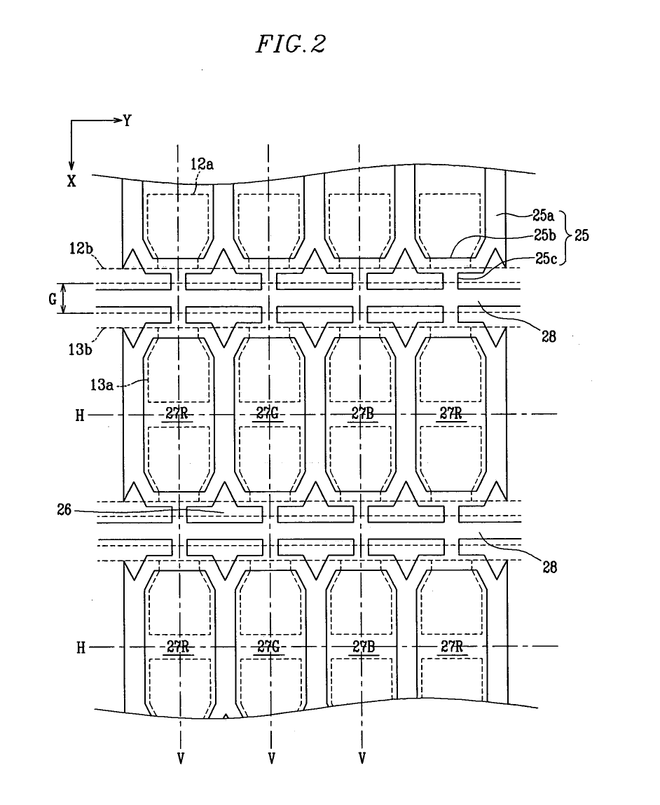

FIG. 1 is a partial exploded perspective view of a plasma display panel according to a first embodiment of the present invention, and FIG. 2 is a partial plan view of the plasma display panel of FIG. 1.

A plasma display panel (PDP) according to the first embodiment includes first substrate 10 and second substrate 20 provided substantially in parallel with a predetermined gap therebetween. A plurality of discharge cells 27R, 27G, 27B in which plasma discharge takes place are defined by barrier ribs 25 between first substrate 10 and second substrate 20. Discharge sustain electrodes 12, 13 are formed on first substrate 10, and address electrodes 21 are formed on second substrate 20. This basic structure of the PDP will be described in greater detail below.

A plurality of address electrodes 21 are formed along one direction (X-axis direction in the drawings) on a surface of second substrate 20 opposing first substrate 10. Address electrodes 21 are formed in a striped pattern with a uniform, predetermined interval between adjacent address electrodes 21. Dielectric layer 23 is formed on the surface of second substrate 20 on which address electrodes 21 are formed. Dielectric layer 23 may be formed extending over this entire surface of second substrate 20 to thereby cover address electrodes 21. In this embodiment, although address electrodes 21 were described as being provided in a striped pattern, the present invention is not limited to this configuration and address electrodes 21 may be formed in a variety of different patterns and shapes.

Barrier ribs 25 define the plurality of discharge cells 27R, 27G, 27B, and also non-discharge regions 26 in the gap between first substrate 10 and second substrate 20. In one embodiment barrier ribs 25 are formed over dielectric layer 23, which is provided on second substrate 20 as described above. Discharge cells 27R, 27G, 27B designate areas in which discharge gas is provided and where gas discharge is expected to take place with the application of an address voltage and a discharge sustain voltage. Non-discharge regions 26 are areas where a voltage is not applied such that gas discharge (i.e., illumination) is not expected to take place therein. Non-discharge regions 26 are areas that are at least as big as a thickness of distal ends of barrier ribs 25.

Non-discharge regions 26 defined by barrier ribs 25 are formed in areas encompassed by discharge cell abscissas H and ordinates V that pass through centers of each of the discharge cells 27R, 27G, 27B, and that are respectively aligned with direction Y and direction X. In one embodiment, non-discharge regions 26 are centered between adjacent abscissas H and adjacent ordinates V. Stated differently, in one embodiment each pair of discharge cells 27R, 27G, 27B adjacent to one another along direction X has a common non-discharge region 26 with another such pair of discharge cells 27R, 27G, 27B adjacent along direction Y. With this configuration realized by barrier ribs 25, each of the non-discharge regions 26 has an independent cell structure.

Non-discharge regions 26 act to expel heat generated in the PDP as a result of discharge in discharge cells 27R, 27G, 27B. This helps make the temperature over all areas of the PDP uniform, thereby overcoming the problem of bright image stickings caused by the concentration of heat in specific areas.

Discharge cells 27R, 27G, 27B adjacent in the direction discharge sustain electrodes 12, 13 are mounted (direction Y) formed sharing at least one of the barrier ribs 25. Also, each of the discharge cells 27R, 27G, 27B is formed with ends that reduce in width in the direction of discharge sustain electrodes 12, 13 (direction Y) as a distance from a center of each of the discharge cells 27R, 27G, 27B is increased in the direction address electrodes 21 are provided (direction X). That is, as shown in FIG. 1, a width Wc of a mid-portion of discharge cells 27R, 27G, 27B is greater than a width We of the ends of discharge cells 27R, 27G, 27B, with width We of the ends decreasing up to a certain point as the distance from the center of the discharge cells 27R, 27G, 27B is increased. Therefore, in the first embodiment, the ends of discharge cells 27R, 27G, 27B are formed in the shape of a trapezoid (with its base removed) until reaching a predetermined location where barrier ribs 25 close off discharge cells 27R, 27G, 27B. This results in each of the discharge cells 27R, 27G, 27B having an overall planar shape of an octagon.

Phosphor layers 29R, 29G, 29B comprised respectively of red (R), green (G), and blue (B) phosphors are deposited with discharge cells 27R, 27G, 27B.

Barrier ribs 25 defining non-discharge regions 26 and discharge cells 27R, 27G, 27B in the manner described above include first barrier rib members 25a that are parallel to address electrodes 21, second barrier rib members 25b that define the ends of discharge cells 27R, 27G, 27B as described above and so are not parallel to address electrodes 21, and bridge barrier rib members 25c. First barrier rib members 25a and second barrier rib members 25b define discharge cells 27R, 27G, 27B. Bridge barrier rib members 25c are formed extending between discharge cells 27R, 27G, 27B adjacent along the direction of address electrodes 21.

Also, one transverse barrier rib 28 is formed extending between each pair of adjacent rows of discharge cells 27R, 27G, 27B, where the rows of discharge cells 27R, 27G, 27B are formed by the same and are adjacent in the direction substantially perpendicular to address electrodes 21. Transverse barrier ribs 28, therefore, intersect non-discharge regions 26, and extend between bridge barrier rib members 25c adjacent along the same direction transverse barrier ribs 28 are formed.

With respect to first substrate 10, a plurality of discharge sustain electrodes 12, 13 are formed on the surface of first substrate 10 opposing second substrate 20. Discharge sustain electrodes 12, 13 are extended in a direction (direction Y) substantially perpendicular to the direction (direction X) of address electrodes 21.

Discharge sustain electrodes 12, 13 respectively include bus electrodes 12b, 13b that are formed in a striped pattern, and protrusion electrodes 12a, 13a that are formed extended from bus electrodes 12b, 13b, respectively. In one embodiment, for each row of discharge cells 27R, 27G, 27B along direction Y, bus electrodes 12b are extended outside of one end of discharge cells 27R, 27G, 27B over corresponding second barrier rib members 25b, and bus electrodes 13b are extended outside of an opposite end of discharge cells 27R, 27G, 27B over corresponding second barrier rib members 25b. Therefore, each of discharge cells 27R, 27G, 27B has one of the bus electrodes 12b positioned outside of one end, and one of the bus electrodes 13b positioned outside its other end.

Further, for each row of discharge cells 27R, 27G, 27B along direction Y, protrusion electrodes 12a overlap and protrude from corresponding bus electrode 12b into the areas of the discharge cells 27R, 27G, 27B. Protrusion electrodes 13a overlap and protrude from the corresponding bus electrode 13b into the areas of discharge cells 27R, 27G, 27B. Therefore, one protrusion electrode 12a and one protrusion electrode 13a are formed opposing one another in each area corresponding to each of the discharge cells 27R, 27G, 27B.

With this configuration, bus electrodes 12b, 13b do not pass into discharge cells 27R, 27G, 27B such that there does not occur a reduction in brightness (caused by the fact that bus electrodes are typically made of metal). In one embodiment, protrusion electrodes 12a, 13a are made of transparent electrodes. However, the present invention is not limited in this regard and it is possible to realize protrusion electrodes 12a, 13a using metal or other opaque materials.

In addition, by mounting bus electrodes 12b, 13b on second barrier rib members 25b as described above, discharge does not occur in a gap G between bus electrodes 12b, 13b of discharge cells 27R, 27G, 27B adjacent along the direction of address electrodes 21. For example, in the case where the gap G between bus electrodes 12b, 13b of discharge cells 27R, 27G, 27B adjacent along the direction of address electrodes 21 is 140 μm or less, the possibility of unnecessary discharge taking place in the gap G is significantly diminished.

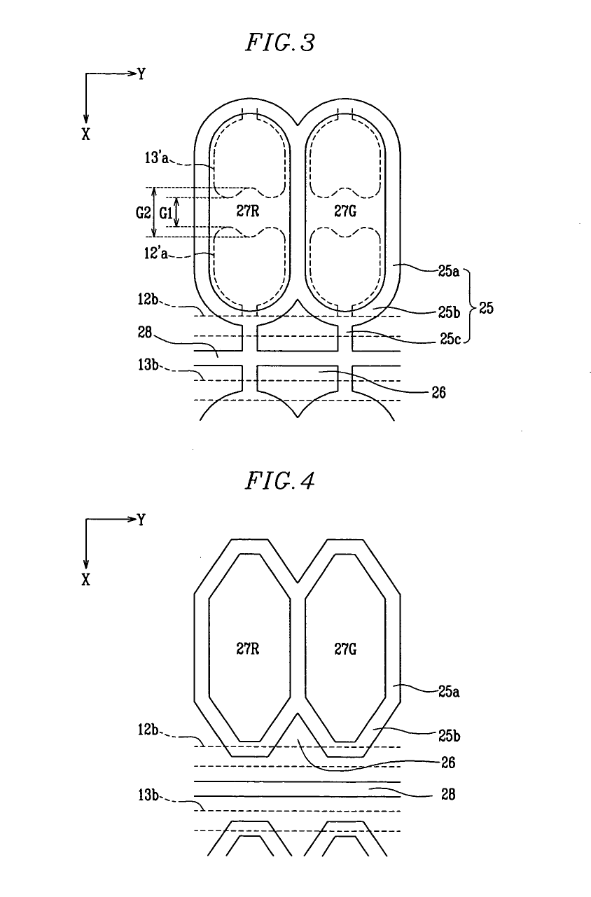

FIG. 3 is a partial plan view of select elements in a PDP according to a second embodiment of the present invention. In the PDP of the second embodiment, using the basic structure of the first embodiment, the configuration of the discharge sustain electrodes is varied.

With reference to FIG. 3, and using discharge cells 27R, 27G and related elements to illustrate the entire altered structure,

With lengths of discharge cells 27R, 27G, 27B being provided along the direction of address electrodes 21 (direction X), ends of discharge cells 27R, 27G, 27B are rounded into an arc shape.

Distal ends of protrusion electrodes 12′a, 13′a are formed such that center areas along direction Y are indented. Therefore, in each of the discharge cells 27R, 27G, 27B, first discharge gap G1 and second discharge gap G2 of different sizes are formed between opposing protrusion electrodes 12′a, 13′a. That is, second discharge gaps G2 (or long gaps) are formed where the indentations of protrusion electrodes 12′a, 13′a oppose one another, and first discharge gaps G1 (or short gaps) are formed where the areas to both sides of the indentations of protrusion electrodes 12′a, 13′a oppose one another. Accordingly, plasma discharge, which initially occurs at center areas of discharge cells 27R, 27G, 27B, is more efficiently diffused such that overall discharge efficiency is increased.

The distal ends of protrusion electrodes 12′a, 13′a may be formed with only indented center areas such that protruded sections are formed to both sides of the indentations, or may be formed with the protrusions to both sides of the indentations extending past a reference straight line r formed along direction Y. Further, protrusion electrodes 12′a, 13′a providing the pair of the same positioned within each of the discharge cells 27R, 27G, 27B may be formed as described above, or only one of the pair may be formed with the indentations and protrusions.

The discharge sustain electrodes are positioned with first and second gaps G1, G2 interposed therebetween to thereby reduce a discharge firing voltage Vf. Accordingly, in the second embodiment, the amount of Xenon contained in the discharge gas may be increased without increases in the discharge firing voltage Vf. The discharge gas contains 10% or more Xenon. In one embodiment, the discharge gas contains 10-60% Xenon. With the increased Xenon content, vacuum ultraviolet rays may be emitted with a greater intensity to thereby enhance screen brightness.

In the second embodiment, the configuration of both the discharge cells and the protrusions are described as being changed from the first embodiment. However, the second embodiment is not limited in this regard and it is also possible to selectively alter the formation of only the discharge cells or the protrusions.

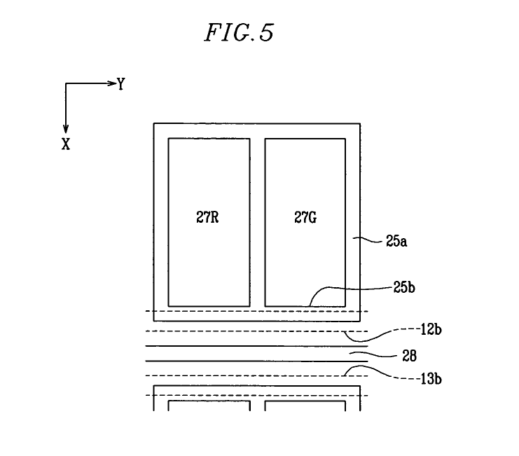

FIG. 4 is a partial plan view of select elements in a PDP according to a third embodiment of the present invention, and FIG. 5 is a partial plan view of select elements in a PDP according to a fourth embodiment of the present invention. In particular, non-discharge regions are formed in a line configuration between rows of discharge cells.

In the PDP of the third embodiment, bridge barrier rib members 25c of the first embodiment are not included in this configuration. As a result, discharge cells 27R, 27G adjacent along the direction of bus electrodes 12b, 13b share one of the first barrier rib members 25a, and second barrier rib members 25b define ends of discharge cells 27R, 27G. Further, in order to prevent unnecessary discharge between bus electrodes 12b, 13b, transverse barrier ribs 28 are mounted in non-discharge regions 26 between second barrier rib members 25b and between rows of discharge cells 27R, 27G formed along the direction of bus electrodes 12b, 13b (direction Y).

In the PDP of the fourth embodiment of FIG. 5, except for forming discharge cells 27R, 27G in a rectangular configuration, all other aspects of this embodiment are substantially identical to the above embodiments.

Although not shown in the drawings, the various configurations of the discharge sustain electrodes of FIGS. 1-3 may be applied or combined to the third and fourth embodiments all while falling within the scope of the present invention.

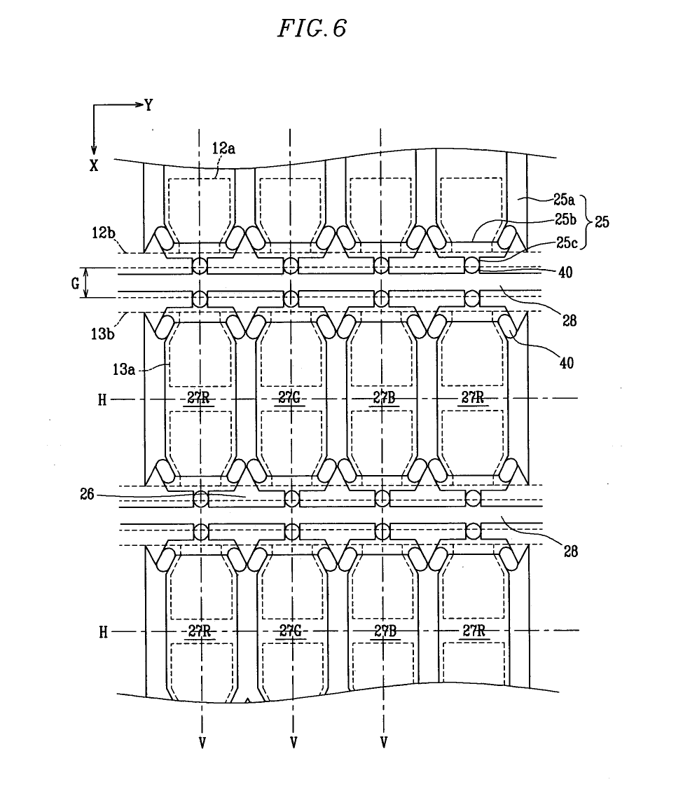

FIG. 6 is a partial plan view of a PDP according to a fifth embodiment of the present invention.

In the fifth embodiment, the basic configuration of the barrier ribs and electrodes of the first embodiment is used. However, ventilation paths 40 are formed on second barrier rib members 25b. Ventilation paths 40 allow for more effective and smoother evacuation of the PDP during manufacture.

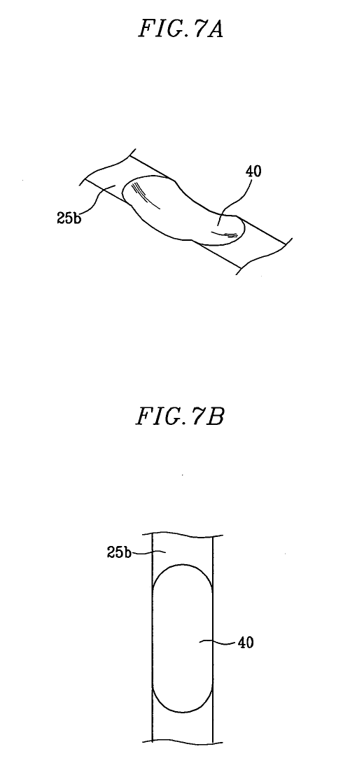

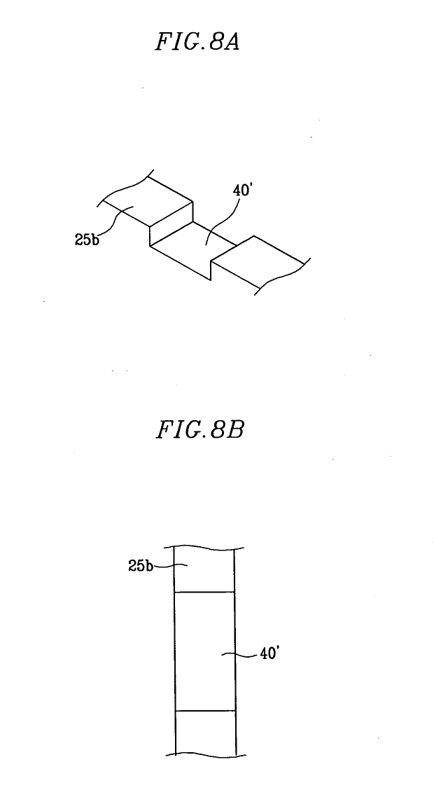

Ventilation paths 40 are formed as grooves on second barrier rib members 25b such that non-discharge regions 26 and discharge cells 27R, 27G, 27B are in communication. When viewed from above, the grooves forming ventilation paths 40 may be substantially elliptical as shown in FIGS. 7A and 7B, or may be substantially rectangular as shown in FIGS. 8A and 8B. However, the grooves are not limited to any one shape and may be formed in a variety of ways as long as there is communication between non-discharge regions 26 and discharge cells 27R, 27G, 27B.

Ventilation paths 40 may be formed not only on upper (distal) surfaces of second barrier rib members 25b, but may also be formed on upper surfaces of bridge barrier rib members 25c to thereby communicate adjacent non-discharge regions 26.

In the PDP having ventilation paths 40 as described above, air in the PDP including air in discharge cells 27R, 27G, 27B may be easily evacuated to thereby result in a more complete vacuum state within the PDP.

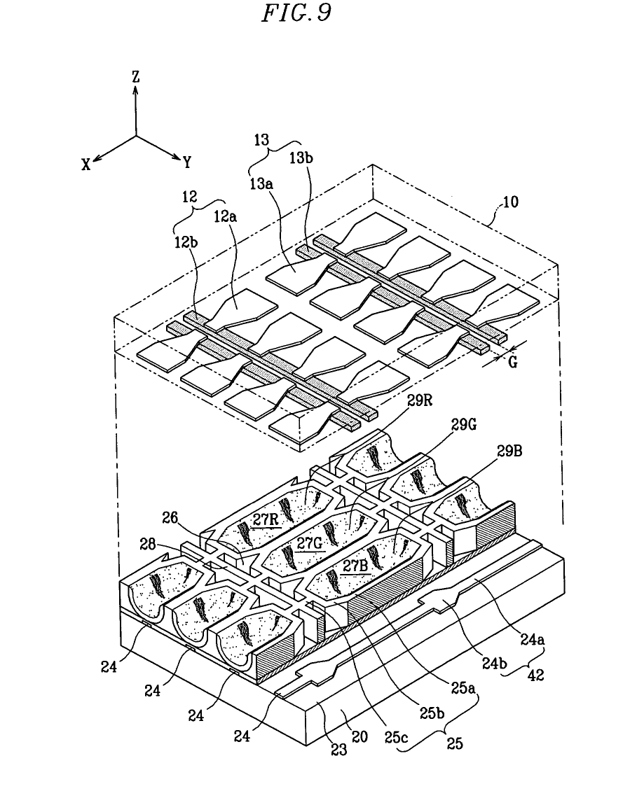

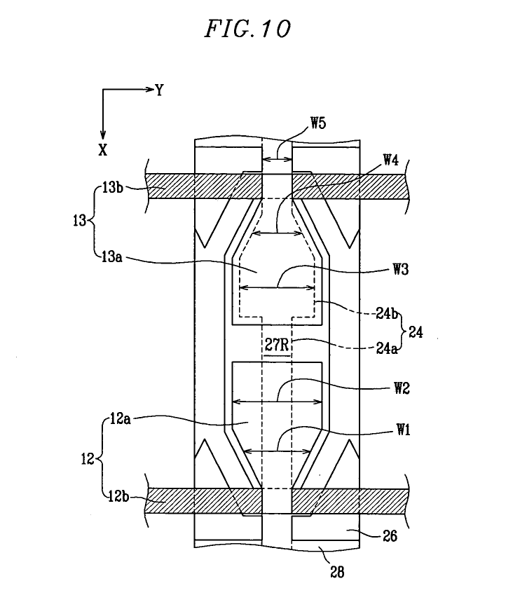

FIG. 9 is a partial exploded perspective view of a PDP according to a sixth embodiment of the present invention, and FIG. 10 is a partial enlarged view of select elements of the PDP of FIG. 9.

In the PDP according to the sixth embodiment, barrier ribs 25 define non-discharge regions 26 and discharge cells 27R, 27G, 27B as in the first embodiment. Further, discharge sustain electrodes 12, 13 are formed along a direction (direction Y) substantially perpendicular to the direction address electrodes 24 are formed. Discharge sustain electrodes 12, 13 include bus electrodes 12b, 13b, respectively, that are mounted to the outside of the regions of discharge cells 27R, 27G, 27B to thereby intersect non-discharge regions 26, and protrusion electrodes 12a, 13a, respectively, that are extended from bus electrodes 12b, 13b such that a pair of protrusion electrodes 12a, 13a oppose one another within each discharge cells 27R, 27G, 27B.

Discharge sustain electrodes 12 are display electrodes, and discharge sustain electrodes 13 are scan electrodes, according to their function.

In the sixth embodiment, address electrodes 24 include enlarged regions 24b formed corresponding to the shape and location of protrusion electrodes 13a of scan electrodes 13. Enlarged regions 24b increase an area of scan electrodes 13 that oppose address electrodes 24. In more detail, address electrodes 24 include line regions 24a formed along direction X, and enlarged regions 24b formed at predetermined locations and expanding along direction Y corresponding to the shape of protrusion electrodes 13a as described above.

As shown in FIG. 10, when viewed from a front of the PDP, areas of enlarged regions 24b of address electrodes 24 opposing distal ends of protrusions 13a of scan electrodes 13 are substantially rectangular having width W3, and areas of enlarged regions 24b of address electrodes 24 opposing proximal ends of protrusions 13a of scan electrodes 13 are substantially wedge-shaped having width W4 that is less than width W3 and decreases gradually as bus electrodes 13b are neared. With width W5 corresponding to the width of line regions 24a of address electrodes 24, the following inequalities are maintained: W3>W5 and W4>W5.

With the formation of enlarged regions 24b at areas opposing scan electrodes 13 of address electrodes 24 as described above, address discharge is activated when an address voltage is applied between address electrodes 24 and scan electrodes 13, and the influence of display electrodes 12 is not received. Accordingly, in the PDP of the sixth embodiment, address discharge is stabilized such that crosstalk is prevented during address discharge and sustain discharge, and an address voltage margin is increased.

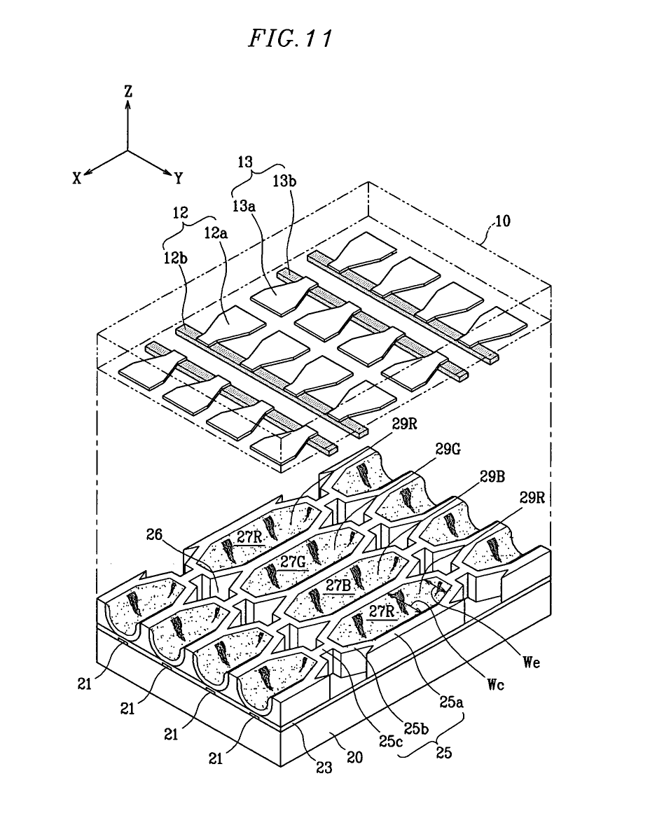

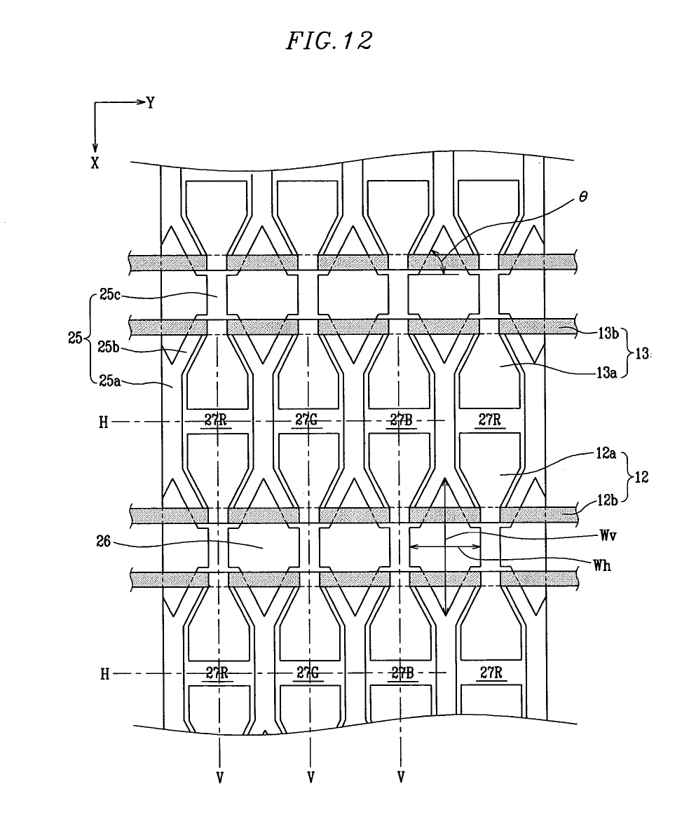

FIG. 11 is a partial exploded perspective view of a PDP according to a seventh embodiment of the present invention, and FIG. 12 is a partial plan view of the plasma display panel of FIG. 11.

In the seventh embodiment, using the basic configuration of the first embodiment, barrier ribs 25 define non-discharge regions 26 and discharge cells 27R, 27G, 27B. Barrier ribs 25 include first barrier rib members 25a, second barrier rib members 25b, and bridge barrier rib members 25c.

First barrier rib members 25a substantially parallel to address electrodes 21, and second barrier rib members 25b that are not parallel to address electrodes 21, define discharge cells 27R, 27G, 27B. Bridge barrier rib members 25c are formed extending between discharge cells 27R, 27G, 27B adjacent along the direction of address electrodes 21 to interconnect second barrier rib members 25b. One or more bridge barrier rib members 25c may be formed between each such pair of discharge cells 27R, 27G, 27B. In the seventh embodiment, only one barrier rib member 25c is formed between each pair of discharge cells 27R, 27G, 27B. In one embodiment, distal end widths of bridge barrier rib members 25c are substantially identical to distal end widths of first barrier rib members 25a.

With the formation of bridge barrier rib members 25c, stability of barrier rib fabrication is ensued. That is, barrier ribs 25 maintain their formation and do not break down during sandblasting and other such fabrication processes.

Referring to FIG. 12, non-discharge regions 26 formed by second barrier rib members 25b and bridge barrier rib members 25c have a ratio of a vertical width Wv (along the direction of address electrodes 21) to horizontal width Wh (along the direction perpendicular to address electrodes 21) that is between 1 and 3. As an example, the horizontal width may be 100-500 μm and the vertical width may be 200-100 μm.

Further, an angle θ between a horizontal line which is drawn along the direction perpendicular to address electrodes 21 and first barrier rib members 25a is adjusted to vary a shape and size of non-discharge regions. The angle θ may be in the range of between 5 and 70 degrees.

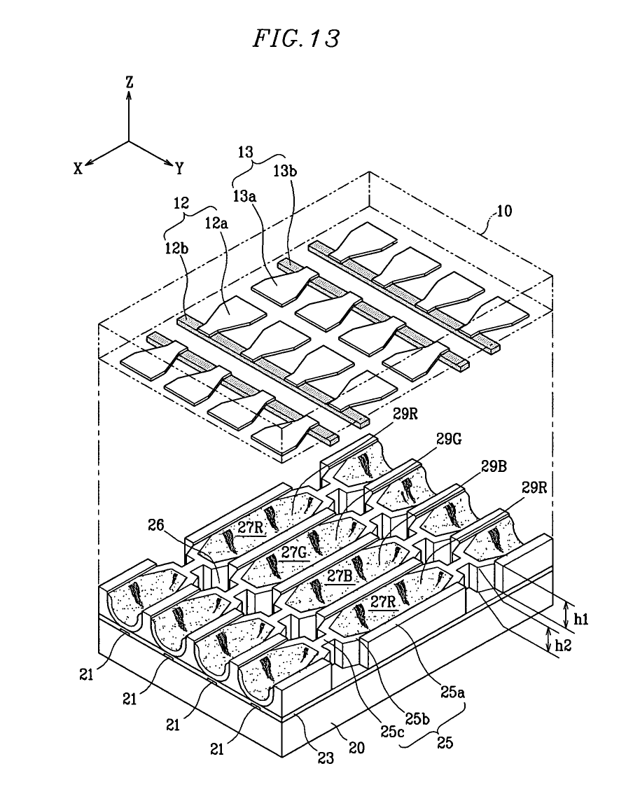

FIG. 13 is a partial exploded perspective view of a modified example of the plasma display panel of FIG. 11.

Heights of first barrier rib members 25a and second barrier rib members 25b that form discharge cells 27R, 27G, 27B are varied. In particular, height h1 of first barrier rib members 25a is greater than height h2 of second barrier rib members 25b. As a result, exhaust spaces are formed between first substrate 10 and second substrate 20 to thereby enable more effective and smoother evacuation of the PDP during manufacture. It is also possible for height h1 of first barrier rib members 25a to be less than height h2 of second barrier rib members 25b.

Eighth and ninth embodiments of the present invention will be described below. PDPs of the eighth and ninth embodiments use the basic configuration of the PDP of the seventh embodiment. However, the structure of barrier ribs on second substrate 20 is varied to thereby improve discharge efficiency. Like reference numerals will be used for elements identical to those in the previously described embodiments.

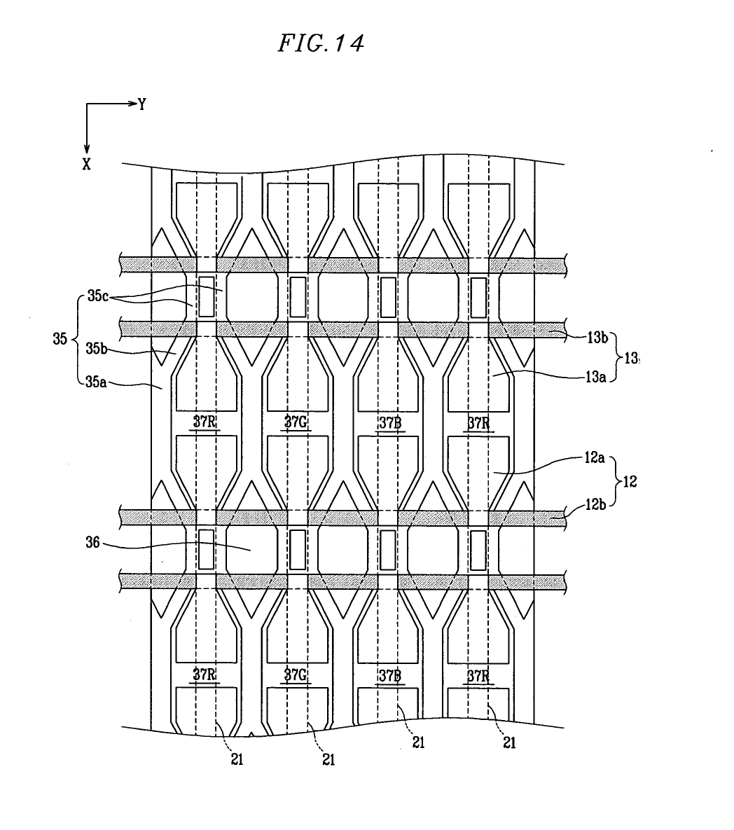

FIG. 14 is a partial plan view of a PDP according to an eighth embodiment of the present invention.

In the PDP of the eighth embodiment, barrier ribs 35 define non-discharge regions 36 and discharge cells 37R, 37G, 37B. Barrier ribs 35 include first barrier rib members 35a, second barrier rib members 35b, and bridge barrier rib members 35c.

First barrier rib members 35a substantially parallel to address electrodes 21, and second barrier rib members 35b that are not parallel to address electrodes 21, define discharge cells 37R, 37G, 37B. Bridge barrier rib members 35c are formed extending between discharge cells 37R, 37G, 37B adjacent along the direction of address electrodes 21 to interconnect second barrier rib members 35b. In the eighth embodiment, a pair of bridge barrier rib members 35c is formed between each such pair of discharge cells 37R, 37G, 37B. All other aspects of the eighth embodiment such as the formation of discharge cells 37R, 37G, 37B, formation of discharge sustain electrodes 12, 13, and the relation with respect to position between non-discharge regions 36 and discharge cells 37R, 37G, 37B are substantially identical to the seventh embodiment.

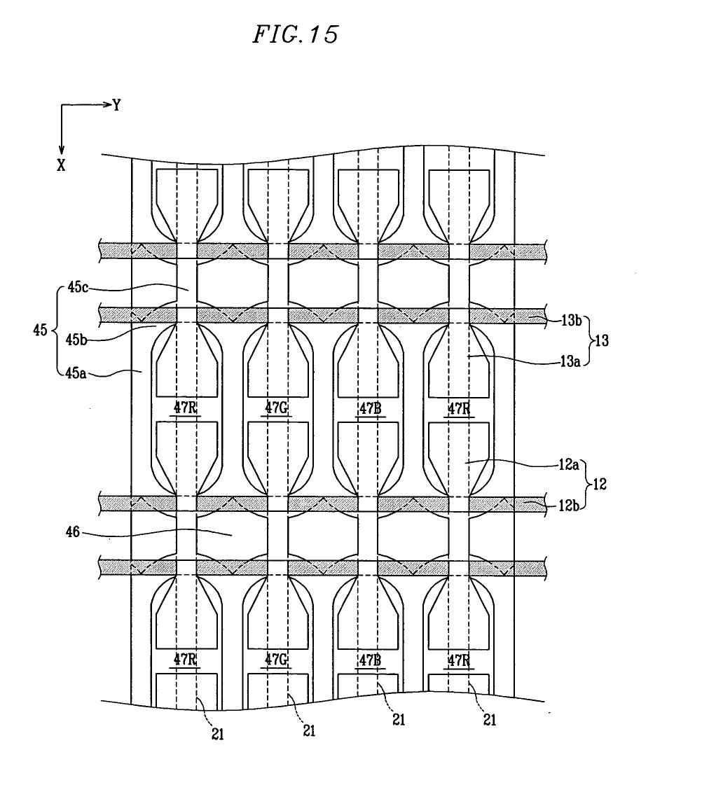

FIG. 15 is a partial plan view of a PDP according to a ninth embodiment of the present invention.

In the PDP of the ninth embodiment, barrier ribs 45 defining non-discharge regions 46 and discharge cells 47R, 47G, 47B include first barrier rib members 45a, second barrier rib members 45b, and bridge barrier rib members 45c.

First barrier rib members 45a substantially parallel to address electrodes 21, and second barrier rib members 45b that are not parallel to address electrodes 21, define discharge cells 47R, 47G, 47B. Bridge barrier rib members 45c are formed extending between discharge cells 47R, 47G, 47B adjacent along the direction of address electrodes 21 to interconnect second barrier rib members 45b. In the ninth embodiment, second barrier rib members 45b are arc-shaped such that ends of discharge cells 47R, 47B, 47B along the direction of address electrodes 21 are also in this shape. All other aspects of the ninth embodiment such as the formation of discharge cells 47R, 47G, 47B, formation of discharge sustain electrodes 12, 13, and the relation with respect to position between non-discharge regions 46 and discharge cells 47R, 47G, 47B are substantially identical to the seventh embodiment.

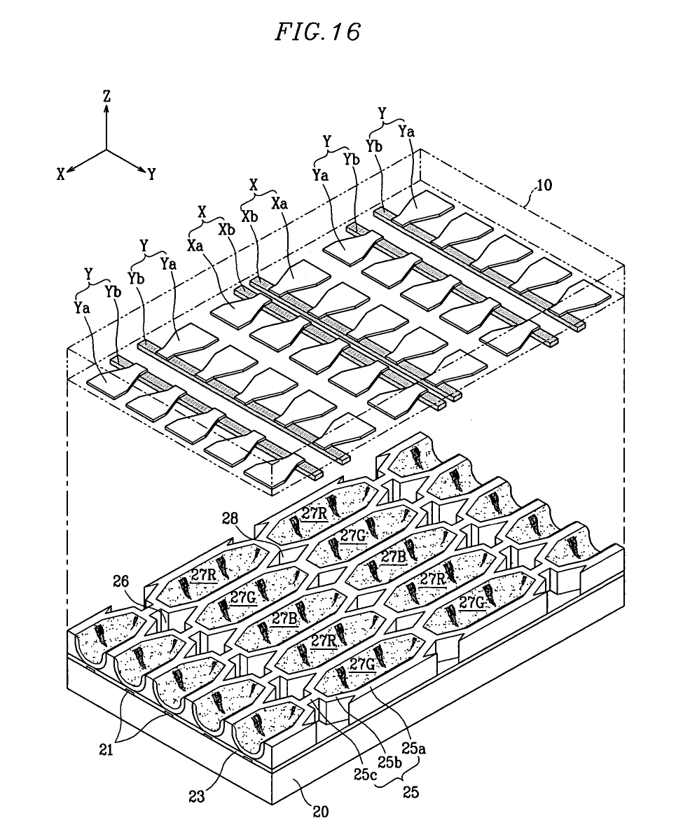

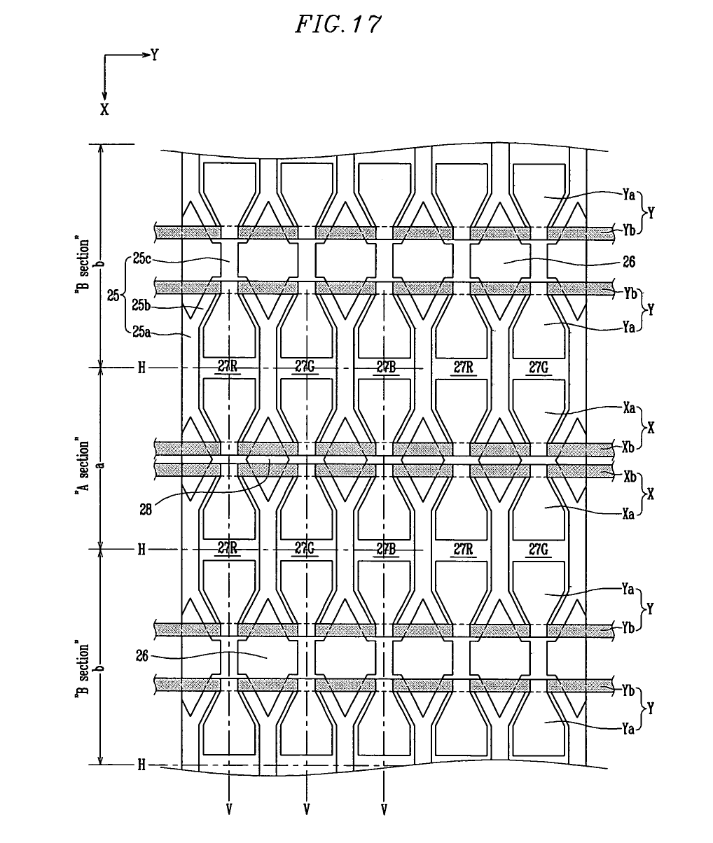

FIG. 16 is a partial exploded perspective view of a PDP according to a tenth embodiment of the present invention, and FIG. 17 is a partial plan view of the plasma display panel of FIG. 16.

A PDP of the tenth embodiment has the basic barrier rib and electrode structure of the seventh embodiment. That is, barrier ribs 25 define a plurality of non-discharge regions 26, 28, and discharge cells 27R, 27G, 27B in the gap between first substrate 10 and second substrate 20. Non-discharge regions 26, 28 are formed in areas encompassed by discharge cell abscissas H and ordinates V that pass through centers of each of the discharge cells 27R, 27G, 27B, and that are respectively aligned with direction Y and direction X.

In this embodiment, a pitch between centers of discharge cells 27R, 27G, 27B, and along the direction of address electrodes 21 is varied alternatingly along the same direction. That is, with reference to FIG. 17, two different pitches a, b are used between centers of discharge cells 27R, 27G, 27B (with a being less than by. If the interval of pitch a is referred to as “A section”, and the interval of pitch b is referred to as “B section”, discharge cells 27R, 27G, 27B are formed such that A sections and B sections are alternatingly formed along the direction of address electrodes 21.

Barrier ribs 25 forming discharge cells 27R, 27G, 27B include first barrier rib members 25a formed along the direction of address electrodes 21, and second barrier rib members 25b that are not parallel to address electrodes 21 and also intersect the same. In the B sections, bridge barrier rib members 25c are formed between discharge cells 27R, 27G, 27B adjacent along the direction of address electrodes 21, whereas bridge barrier rib members 25c are not formed in the A sections. In the case of the A sections, discharge cells 27R, 27G, 27B are immediately adjacent to each other along the direction of address electrodes 21. As a result of this configuration, the pitch between centers of discharge cells 27R, 27G, 27B in B sections is greater than the pitch between centers of discharge cells 27R, 27G, 27B in A sections.

Discharge sustain electrodes X, Y formed on first substrate 10 are realized through display electrodes (X electrodes) and scan electrodes (Y electrodes) that are extended in a direction (direction Y) substantially perpendicular to the direction (direction X) of address electrodes 21.

Discharge sustain electrodes X, Y respectively include bus electrodes Xb, Yb that are formed in a striped pattern, and protrusion electrodes Xa, Ya that are formed extended from bus electrodes Xb, Yb, respectively. In one embodiment, for each row of discharge cells 27R, 27G, 27B along direction Y, bus electrodes Xb are extended outside of one end of discharge cells 27R, 27G, 27B over corresponding second barrier rib members 25b, and bus electrodes Yb are extended outside of an opposite end of discharge cells 27R, 27G, 27B over corresponding second barrier rib members 25b. Therefore, each of discharge cells 27R, 27G, 27B has one of the bus electrodes Xb positioned outside of one end, and one of the bus electrodes Yb positioned outside its other end.

Further, for each row of discharge cells 27R, 27G, 27B along direction Y, protrusion electrodes Xa overlap and protrude from corresponding bus electrode Xb into the areas of the discharge cells 27R, 27G, 27B. Protrusion electrodes Ya overlap and protrude from the corresponding bus electrode Yb into the areas of discharge cells 27R, 27G, 27B. Therefore, one protrusion electrode Xa and one protrusion electrode Ya are formed opposing one another in each area corresponding to each of the discharge cells 27R, 27G, 27B.

With this configuration, bus electrodes Xb, Yb do not pass into discharge cells 27R, 27G, 27B such that there does not occur a reduction in brightness (caused by the fact that bus electrodes are typically made of metal). In one embodiment, protrusion electrodes Xa, Ya are made of transparent electrodes. However, the present invention is not limited in this regard and it is possible to realize protrusion electrodes Xa, Ya using metal or other opaque materials.

Discharge sustain electrodes X, Y having the above configuration have an overall arrangement structure along the direction of address electrodes 21 alternating between pairs of scan electrodes Y and display electrodes X. Stated differently, there are adjacent pairs of display electrodes X in the A sections, and adjacent pairs of scan electrodes Y in the B sections such that an overall pattern of X-X-Y-Y-X-X-Y-Y, etc. results. As stated above, the pitch between centers of discharge cells 27R, 27G, 27B in the B sections is greater than the pitch between centers of discharge cells 27R, 27G, 27B in the A sections.

With the formation and arrangement of discharge sustain electrodes X, Y as described above, scan electrodes X are made as close together as possible since there is no possibility of mis-discharge between the same, thereby reducing the interval between corresponding discharge cells 27R, 27G, 27B. High resolution images may be obtained as a result.

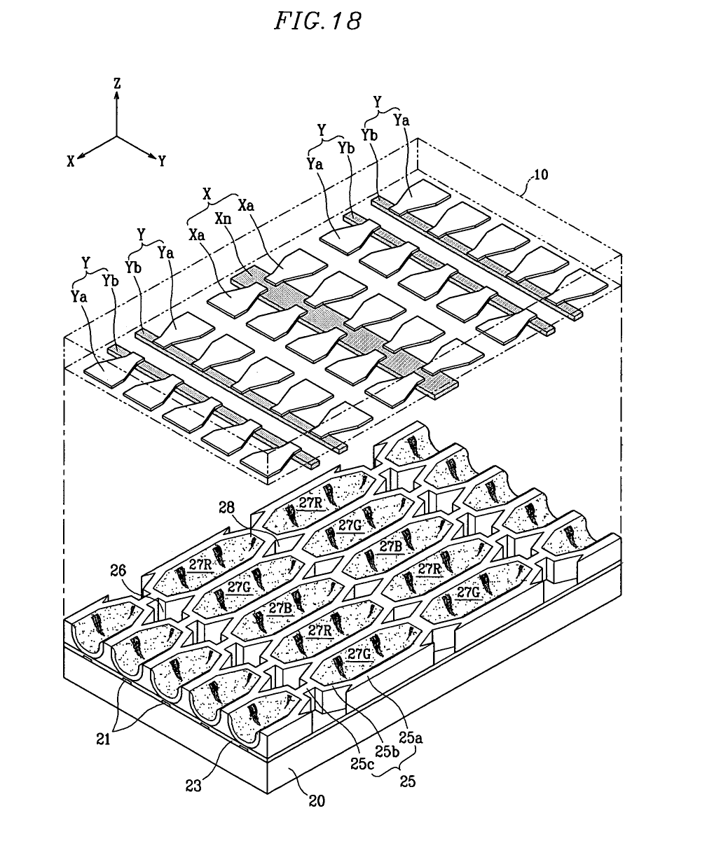

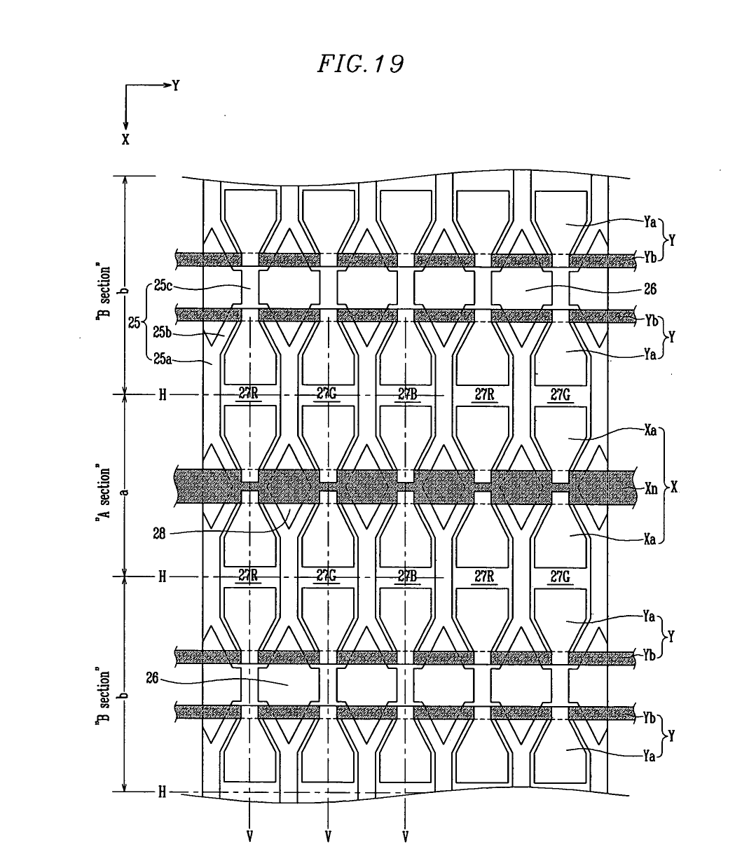

FIG. 18 is a partial exploded perspective view of a PDP according to an eleventh embodiment of the present invention, and FIG. 19 is a partial plan view of the PDP of FIG. 18. The PDP of the eleventh embodiment uses the basic configuration of the tenth embodiment.

A pitch between centers of discharge cells 27R, 27G, 27B, and along the direction of address electrodes 21 is varied alternatingly along the same direction. That is, with reference to FIG. 19, two different pitches a, b are used between centers of discharge cells 27R, 27G, 27B (with a being less than b). If the interval of pitch a is referred to as “A section”, and the interval of pitch b is referred to as “B section”, discharge cells 27R, 27G, 27B are formed such that A sections and B sections are alternatingly formed along the direction of address electrodes 21.

Discharge sustain electrodes X, Y are realized through display electrodes (X electrodes) and scan electrodes (Y electrodes) extended in a direction (direction Y) substantially perpendicular to the direction (direction X) of address electrodes 21. Discharge cells 27R, 27G, 27B adjacent along the direction of address electrodes 21 and in the A sections share a common bus electrode Xn having protrusion electrodes Xa that extend into discharge cells 27R, 27G, 27B, while scan electrodes Y are provided as described with reference to the tenth embodiment. Therefore, the overall pattern of Y-Y-X-Y-Y-X, etc. results.

With the formation and arrangement of discharge sustain electrodes X, Y as described above, bus electrodes Xn of display electrodes X are made as a single unit shared by rows of adjacent discharge cells 27R, 27G, 27B since there is no possibility of mis-discharge between the same, thereby reducing the interval between corresponding discharge cells 27R, 27G, 27B. High resolution images may be obtained as a result.

In one embodiment, a width of bus electrodes Xn of display electrodes X in the direction of address electrodes 21 is greater than a width of bus electrodes Yb of scan electrodes in the same direction. As a result, the opaqueness rate of the gap between discharge cells 27R, 27G, 27B is increased such that bright room contrast is enhanced with increases in material costs and without having to perform additional manufacturing processes.

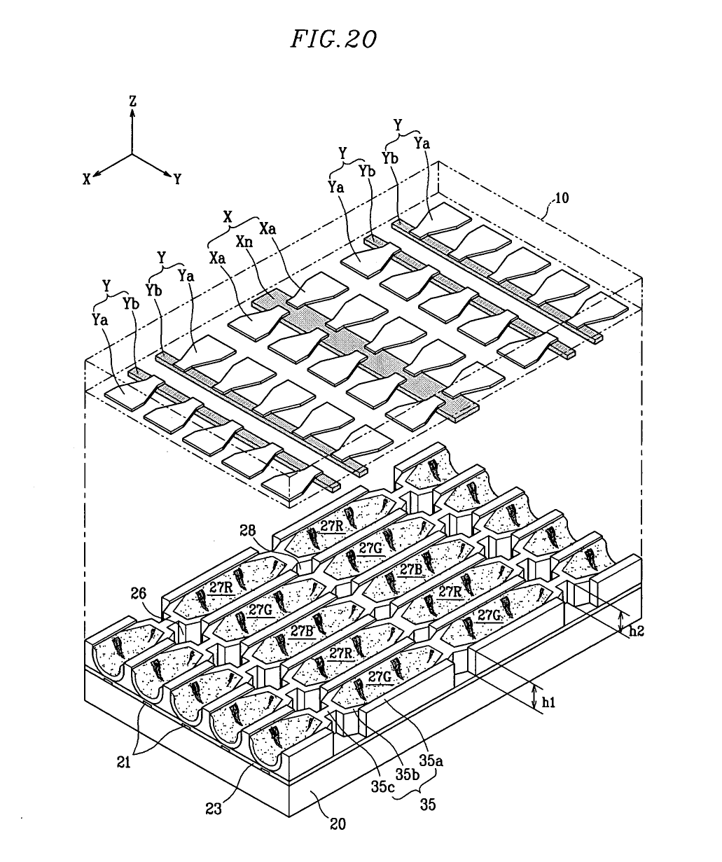

FIGS. 20-22 are drawings showing modified examples of the PDP of FIG. 18. The basic mounting structure of the discharge cells and the basic arrangement of the discharge sustain electrodes of the eleventh embodiment are used, and there are only slight variations in these areas in the modified examples.

Referring to FIG. 20, heights of first barrier rib members 35a and second barrier rib members 35b that form discharge cells 37R, 37G, 37B are varied. In particular, height h1 of first barrier rib members 35a is greater than height h2 of second barrier rib members 35b. As a result, exhaust spaces are formed between first substrate 10 and second substrate 20 to thereby enable more effective and smoother evacuation of the PDP during manufacture. It is also possible for height h1 of first barrier rib members 35a to be less than height h2 of second barrier rib members 35b.

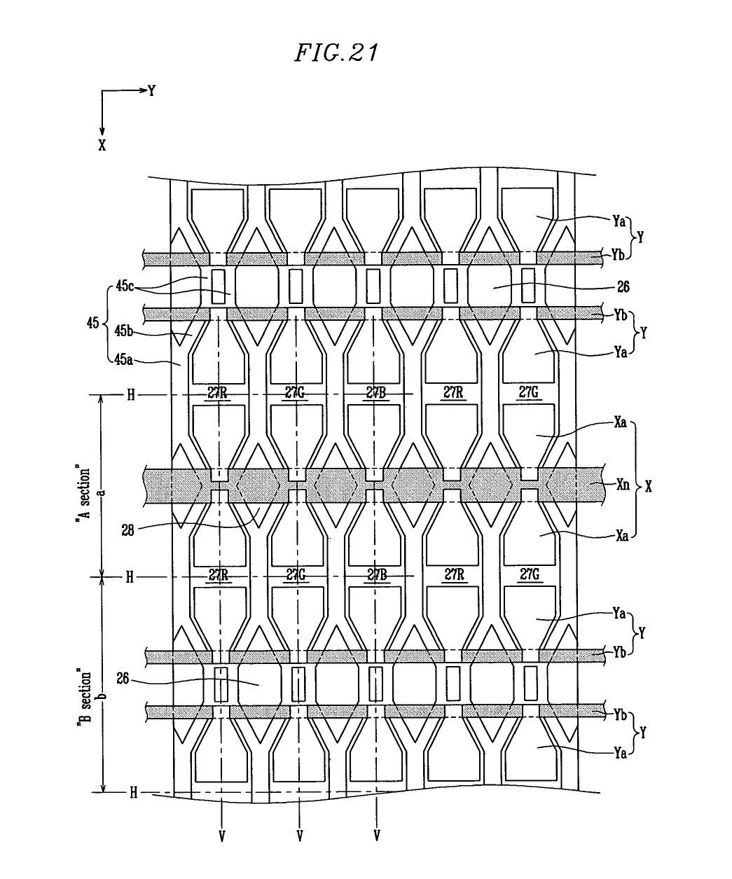

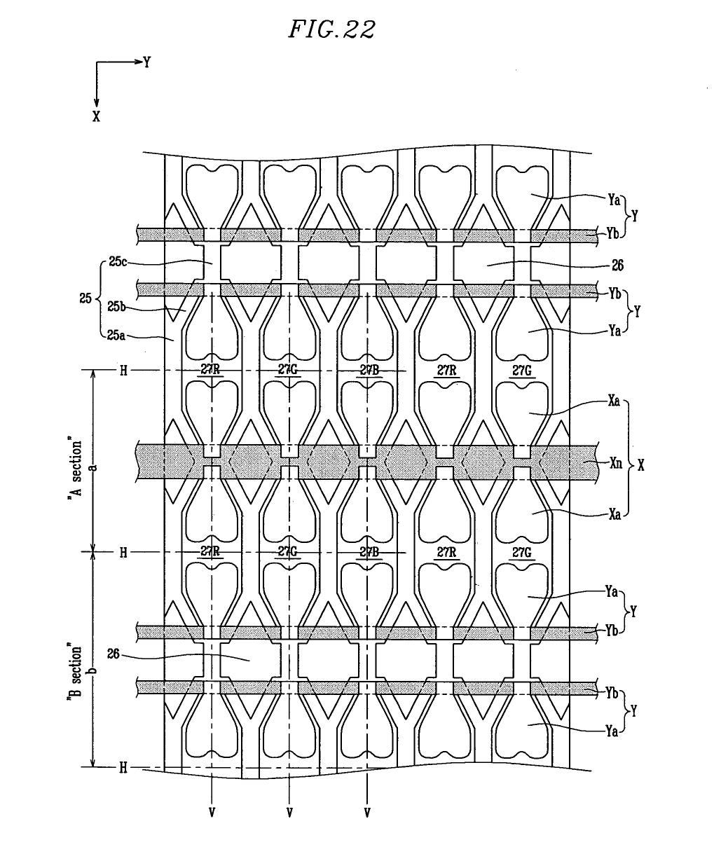

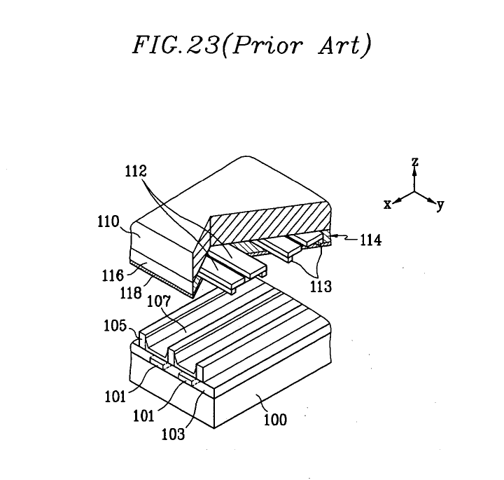

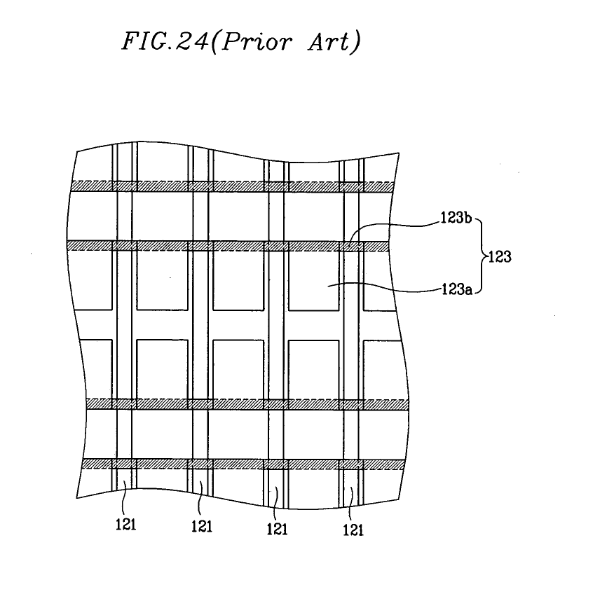

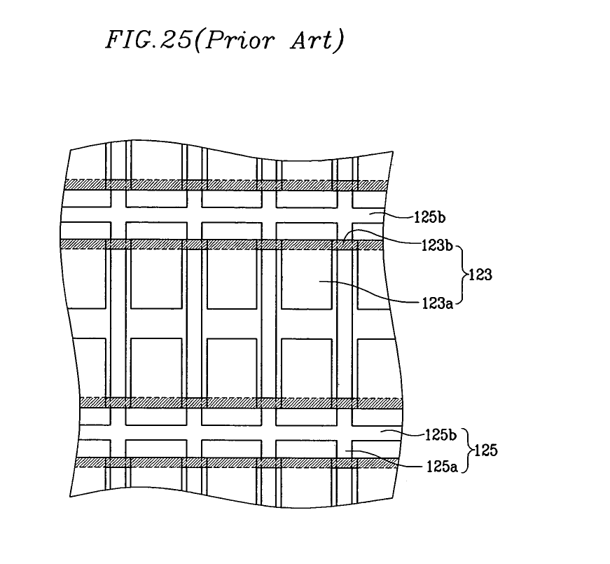

With reference to FIG. 21, bridge barrier rib members 45 are formed between each pair of discharge cells 27R, 27G, 27B adjacent along the direction of address electrodes 21 (direction X).

Referring to FIG. 22, protrusion electrodes Xa, Ya included in each of the discharge sustain electrodes X, Y are formed with indentations formed at center areas of distal ends of protrusion electrodes Xa, Ya. Therefore, in each of the discharge cells 27R, 27G, 27B, gaps of different sizes are formed between opposing protrusion electrodes Xa, Ya. That is, long gaps are formed where the indentations of protrusion electrodes Xa, Ya oppose one another, and short gaps are formed where the areas to both sides of the indentations of protrusion electrodes Xa, Ya oppose one another. Accordingly, plasma discharge, which initially occurs at center areas of discharge cells 27R, 27G, 27B, is more efficiently diffused such that overall discharge efficiency is increased.

The features of the eighth through eleventh embodiments and their modified examples described above may be applied to the first through sixth embodiments.

Although embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A plasma display panel, comprising:
a first substrate and a second substrate provided opposing one another with a predetermined gap therebetween;
address electrodes formed on the second substrate;
barrier ribs mounted between the first substrate and the second substrate, the barrier ribs defining a plurality of discharge cells and a plurality of non-discharge regions;
phosphor layers formed within each of the discharge cells; and
discharge sustain electrodes formed on the first substrate,
wherein the non-discharge regions are formed in areas encompassed by discharge cell abscissas that pass through centers of adjacent discharge cells and discharge cell ordinates that pass through centers of adjacent discharge cells, the non-discharge regions having a width that is at least as large as a width of an end of barrier ribs opposite an end adjacent to the second substrate, and
wherein a transverse barrier rib is formed extending between a pair of adjacent rows of discharge cells, where rows of discharge cells are formed by the same adjacent in the direction substantially perpendicular to address electrodes, the transverse barrier ribs intersecting the non-discharge regions.

2. The plasma display panel of claim 1, wherein the barrier ribs forming the discharge cells comprise first barrier rib members formed substantially parallel to the direction of the address electrodes, and second barrier rib members formed in a direction that is oblique to the direction of the address electrodes,
wherein there is a space between second barrier rib members adjacent along the direction of the address electrodes, and
wherein the transverse barrier ribs are formed in the spaces between the second barrier rib members.

3. The plasma display panel of claim 2, further comprising at least one bridge barrier rib member interconnecting each pair of second barrier rib members adjacent along the direction of the address electrodes.

4. The plasma display panel of claim 1, wherein each of the discharge cells is formed such that ends of the discharge cells gradually decrease in width along a direction the discharge sustain electrodes are formed as a distance from a center of the discharge cells is increased along a direction the address electrodes are formed.

5. The plasma display panel of claim 4, wherein the ends of the discharge cells are formed substantially in the shape of a trapezoid with its base removed.

6. The plasma display panel of claim 4, wherein the ends of the discharge cells are arc-shaped.

7. The plasma display panel of claim 1, wherein the discharge sustain electrodes include bus electrodes that extend in a direction substantially perpendicular to the direction of the address electrodes and are positioned outside areas of the discharge cells, and protrusion electrodes formed extending from each of the bus electrodes such that a pair of opposing protrusion electrodes is formed within areas corresponding to each discharge cell.

8. The plasma display panel of claim 7, wherein both sides of a proximal end of each of the protrusion electrodes where connected to the bus electrodes are formed substantially uniformly with inner walls of ends of the discharge cells along the direction of the address electrodes.

9. The plasma display panel of claim 7, wherein proximal ends of each of the protrusion electrodes where connected to the bus electrodes are formed decreasing in width along the direction of the bus electrodes as the distance from centers of the discharge cells is increased.

10. The plasma display panel of claim 7, wherein a distal end of at least one of each pair of protrusion electrodes opposite proximal ends connected to and extended from the bus electrodes is formed including an indentation, and a first discharge gap and a second discharge gap of different sizes are formed between distal ends of opposing protrusion electrodes.

11. The plasma display panel of claim 10, wherein the discharge cells are filled with discharge gas containing 10% or more Xenon.

12. The plasma display panel of claim 10, wherein the discharge cells are filled with discharge gas containing 10-60% Xenon.

13. The plasma display panel of claim 1, wherein ventilation paths are formed on the barrier ribs defining the non-discharge regions.

14. The plasma display panel of claim 13, wherein the ventilation paths are formed as grooves in the barrier ribs to communicate the discharge cells with the non-discharge regions.

15. The plasma display panel of claim 1, wherein the discharge sustain electrodes include scan electrodes and display electrodes provided such that one scan electrode and one display electrode correspond to each row of the discharge cells, the scan electrodes and the display electrodes including protrusion electrodes that extend into the discharge cells while opposing one another,
wherein the protrusion electrodes are formed such that a width of proximal ends thereof is smaller than a width of distal ends of the protrusion electrodes, and
wherein the address electrodes include line regions formed along a direction the address electrodes are formed, and enlarged regions formed at predetermined locations and expanding along a direction substantially perpendicular to the direction of the line regions to correspond to the shape of protrusion electrodes of the scan electrodes.

16. The plasma display panel of claim 15, wherein the enlarged regions of the address electrodes are formed to a first width at areas opposing the distal ends of the protrusion electrodes, and to a second width that is smaller than the first width at areas opposing the proximal ends of the protrusion electrodes.

17. A plasma display panel, comprising:
a first substrate and a second substrate provided opposing one another with a predetermined gap therebetween;
address electrodes formed on the second substrate;
barrier ribs mounted between the first substrate and the second substrate, the barrier ribs defining a plurality of discharge cells and a plurality of non-discharge regions;
phosphor layers formed within each of the discharge cells; and
discharge sustain electrodes formed on the first substrate,
wherein the non-discharge regions are formed in areas encompassed by discharge cell abscissas that pass through centers of adjacent discharge cells and discharge cell ordinates that pass through centers of adjacent discharge cells, the non-discharge regions having a width that is at least as large as a width of an end of barrier ribs opposite that adjacent to the second substrate, and
wherein the barrier ribs forming the discharge cells comprise first barrier rib members formed substantially parallel to the direction of the address electrodes, and second barrier rib members formed in a direction that is oblique to the direction of the address electrodes, and
wherein at least one bridge barrier rib member interconnects each pair of second barrier rib members adjacent along the direction of the address electrodes.

18. The plasma display panel of claim 17, wherein the barrier ribs define the non-discharge regions into an independent cell structure.

19. The plasma display panel of claim 17, wherein an end of the bridge barrier rib members opposite an end adjacent to the second substrate is substantially identical to a width of an end of the first barrier rib members opposite an end adjacent to the second substrate.

20. The plasma display panel of claim 17, wherein the second barrier rib members intersect the direction the address electrodes are formed.

21. The plasma display panel of claim 17, wherein the non-discharge regions have a ratio of a vertical width along the direction of the address electrodes to horizontal width along the direction perpendicular to the address electrodes that is between 1 and 3.

22. The plasma display panel of claim 17, wherein each of the discharge cells is formed such that ends of the discharge cells gradually decrease in width along a direction the discharge sustain electrodes are formed as a distance from a center of the discharge cells is increased along a direction the address electrodes are formed.

23. The plasma display panel of claim 17, wherein an angle between a horizontal line drawn along the direction perpendicular to the address electrodes, and first barrier rib members is in the range of 5 and 70 degrees.

24. The plasma display panel of claim 22, wherein the ends of the discharge cells are formed substantially in the shape of a trapezoid with its base removed.

25. The plasma display panel of claim 22, wherein the ends of the discharge cells are arc-shaped.

26. The plasma display panel of claim 17, wherein a height of the first barrier rib members and a height of the second barrier rib members are different.

27. The plasma display panel of claim 26, wherein the height of the first barrier rib members is greater than the height of the second barrier rib members.

28. The plasma display panel of claim 26, wherein the height of the first barrier rib members is less than the height of the second barrier rib members.

29. The plasma display panel of claim 17, wherein the discharge sustain electrodes include bus electrodes that extend in a direction substantially perpendicular the direction of the address electrodes to be positioned outside areas of the discharge cells such that a pair of bus electrodes corresponds to each discharge cell, and protrusion electrodes formed extending from each of the bus electrodes such that a pair of opposing protrusion electrodes is formed within areas corresponding to each discharge cell.

30. The plasma display panel of claim 29, wherein the bus electrodes pass over the second barrier rib members.

31. The plasma display panel of claim 29, wherein the protrusion electrodes are transparent.

32. The plasma display panel of claim 17, wherein ventilation paths are formed on the second barrier rib members.

33. The plasma display panel of claim 32, wherein the ventilation paths are formed as grooves in the second barrier rib members to communicate the discharge cells with the non-discharge regions.

34. The plasma display panel of claim 33, wherein the grooves have substantially an elliptical planar configuration.

35. The plasma display panel of claim 33, wherein the grooves have substantially a rectangular planar configuration.

36. The plasma display panel of claim 17, wherein ventilation paths are formed on the bridge barrier rib members such that at least two adjacent non-discharge regions are in communication.

37. A plasma display panel, comprising:
a first substrate and a second substrate provided opposing one another with a predetermined gap therebetween;
address electrodes formed on the second substrate;
barrier ribs mounted between the first substrate and the second substrate, the barrier ribs defining a plurality of discharge cells and a plurality of non-discharge regions;
phosphor layers formed within each of the discharge cells; and
discharge sustain electrodes formed on the first substrate and including display electrodes and scan electrodes, a pair of one display electrode and one scan electrode being provided for each discharge cell,
wherein the non-discharge regions are formed in areas encompassed by discharge cell abscissas that pass through centers of adjacent discharge cells and discharge cell ordinates that pass through centers of adjacent discharge cells, the non-discharge regions having a width that is at least as large as a width of an end of barrier ribs opposite that adjacent to the second substrate, and
wherein the discharge cells have a pitch between centers of discharge cells adjacent along the direction of the address electrodes that is varied alternatingly along the same direction.

38. The plasma display panel of claim 37, wherein the barrier ribs define the non-discharge regions into an independent cell structure.

39. The plasma display panel of claim 37, wherein each of the discharge cells is formed such that ends of the discharge cells gradually decrease in width along a direction substantially perpendicular the direction of the address electrodes as a distance from a center of the discharge cells is increased along a direction the address electrodes are formed.

40. The plasma display panel of claim 37, wherein the discharge cells are formed such that first pitch sections having a first pitch between centers of discharge cells and second pitch sections having a second pitch between centers of discharge cells, the first pitch being less that the second pitch, are alternatingly formed along the direction of the address electrodes.

41. The plasma display panel of claim 40, wherein the barrier ribs forming the discharge cells include first barrier rib members formed along the direction of the address electrodes, and second barrier rib members that are not parallel to the address electrodes, and
wherein in the second pitch sections, at least one bridge barrier rib member is formed between each pair of the discharge cells adjacent along the direction of the address electrodes, the bridge barrier rib members not being formed in the first pitch sections.

42. The plasma display panel of claim 40, wherein for the first pitch sections, the discharge cells are immediately adjacent to each other along the direction of address electrodes such that the pitch between centers of the discharge cells in the second pitch sections is greater than the pitch between centers of the discharge cells in the first pitch sections, the first pitch sections having a pattern of X-X electrodes and the second pitch sections having a pattern of Y-Y electrodes.

43. A plasma display panel, comprising:
a first substrate and a second substrate provided opposing one another with a predetermined gap therebetween;
address electrodes formed on the second substrate;
barrier ribs mounted between the first substrate and the second substrate, the barrier ribs defining a plurality of discharge cells and a plurality of non-discharge regions;
phosphor layers formed within each of the discharge cells; and
discharge sustain electrodes formed on the first substrate, and including display electrodes and scan electrodes,
wherein the non-discharge regions are formed in areas encompassed by discharge cell abscissas that pass through centers of adjacent discharge cells and discharge cell ordinates that pass through centers of adjacent discharge cells, the non-discharge regions having a width that is at least as large as a width of an end of barrier ribs opposite that adjacent to the second substrate,
wherein the discharge cells are formed such that first pitch sections having a first pitch between centers of discharge cells and second pitch sections having a second pitch between centers of discharge cells, the first pitch being less that the second pitch, are alternatingly formed along the direction of the address electrodes, and
wherein the first pitch sections have one display electrode formed therein, and the second pitch sections have a pair of scan electrodes formed therein.

44. The plasma display panel of claim 43, wherein a width of the display electrodes along the direction of the address electrodes is greater than a width of the scan electrodes along the direction of the address electrodes.

45. The plasma display panel of claim 43, wherein protrusion electrodes are extended from both sides of the display electrodes.

46. The plasma display panel of claim 43, wherein each of the discharge cells is formed such that ends of the discharge cells gradually decrease in width along a direction substantially perpendicular the direction of the address electrodes as a distance from a center of the discharge cells is increased along a direction the address electrodes are formed.

47. The plasma display panel of claim 43, wherein the barrier ribs forming the discharge cells include first barrier rib members formed along the direction of the address electrodes, and second barrier rib members that are not parallel to the address electrodes, and
wherein in the second pitch sections, at least one bridge barrier rib member is formed between each pair of the discharge cells adjacent along the direction of the address electrodes to thereby interconnect the second barrier rib members.

48. The plasma display panel of claim 47, wherein the discharge sustain electrodes include bus electrodes that extend in a direction substantially perpendicular the direction of the address electrodes to be positioned outside areas of the discharge cells such that a pair of bus electrodes corresponds to each discharge cell, and protrusion electrodes formed extending from each of the bus electrodes such that a pair of opposing protrusion electrodes is formed within areas corresponding to each discharge cell, and
wherein the bus electrodes pass over the second barrier rib members.

49. The plasma display panel of claim 48, wherein a distal end of each of the protrusion electrodes opposite proximal ends connected to and extended from the bus electrodes is formed including an indentation.
